(19) United States
(12) Patent Application Publication
(10) Pub. No.: US 2008/0154577 A1
(43) Pub. Date: Jun. 26, 2008

(54) Chunk-based statistical machine translation system

(75) Inventors: Yookyung Kim, Los Altos, CA (US); Jun Huang, Fremont, CA (US); Youssef Billawala, Campbell, CA (US)

Correspondence Address: EMIL CHANG;LAW OFFICES OF EMIL CHANG, 874 JASMINE DRIVE, SUNNYDALE, CA, 94086, US

(73) Assignee: Sehda,Inc.

(21) Appl. No.: 11/645,926

(22) Filed: Dec. 26, 2006

(51) Int. Cl. G06F 17/28

(52) U.S. Cl. 704/2; 704/5

(57) ABSTRACT

Traditional statistical machine translation systems learn all information from a sentence aligned parallel text and are known to have problems translating between structurally diverse languages. To overcome this limitation, the present invention introduces two-level training, which incorporates syntactic chunking into statistical translation. A chunk-alignment step is inserted between the sentence-level and word-level training, which allows differing training for these two sources of information in order to learn lexical properties from the aligned chunks and learn structural properties from chunk sequences. The system consists of a linguistic processing step, two level training, and a decoding step which combines chunk translations of multiple sources and multiple language models.

### FIELD OF INVENTION

The present invention relates to automatic translation systems, and, in particular, statistical machine translation systems and methods.

### BACKGROUND

Recently, significant progress has been made in the application of statistical techniques to the problem of translation between natural languages. The promise of statistical machine translation (SMT) is the ability to produce translation engines automatically without significant human effort for any language pair for which training data is available. However, current SMT approaches based on the classic word-based IBM models (Brown et al. 1993) are known to work better on language pairs with similar word ordering. Recently, strides toward correcting this problem have been made by bilingually learning phrases that can improve the translation accuracy. However, these experiments (Wang 1988, Yamada and Knight 2001, Och et al. 2000, Koehn et al. 2002, Zhang et al. 2003) have neither gone far enough in harnessing the full power of phrasal-translation, nor successfully solved the structural problems in the output translations.

This motivates the present invention of syntactic chunk-based, two-level machine translation methods, which learns vocabulary translations within syntactically and semantically independent units and learns global structural relationships among the chunks separately. The invention not only produces higher quality translations but also needs much less training data than other statistical models since it is considerably more modular and less dependent on training data.

### SUMMARY OF THE INVENTION

The object of the present invention is to provide a chunk-based statistical machine translation system.

Briefly, the present invention performs two separate levels of training to learn lexical and syntactic properties, respectively. To achieve this new model of translation, the present invention introduces chunk alignment into a statistical machine translation system.

Syntactic chunking segments a sentence into syntactic phrases such as noun phrases, prepositional phrases, and verbal clusters without hierarchical relationships between the phrases. In this invention, part-of-speech information and a handful set of chunking rules suffice to perform accurate chunking. Syntactic chunking is performed on both source and target languages independently. The aligned chunks serve not only as the direct source for chunk translation but also as the training material of statistical chunk translation. The translation models such as lexical model, fertility model and distortion model within chunks are learned from the aligned chunks in the chunk-level training.

The translation component of the system comprises of chunk translation, reordering, and decoding. The system chunk parses the sentence into syntactic chunks and translates each chunk by looking up candidate translations from the aligned chunk table and with a statistical decoding method using the translation models obtained during the chunk-level training. Reordering is performed using blocks of chunk translations instead of words, and multiple candidate translation of chunks are decoded using both a word language model and chunk head language model.

### DESCRIPTION OF DRAWINGS

The foregoing and other objects, aspects and advantages of the invention will be better understood from the following detailed description of preferred embodiments of this invention when taken in conjunction with the accompanying drawings in which:

FIG. 1 shows an overview of the training steps of a preferred embodiment of the present invention.

FIG. 2 illustrates certain method steps of the preferred embodiments of the present invention where a sentence may be translated using the models obtained from the training step illustrated in FIG. 1.

FIG. 3 shows a simple English example of text processing step where a sentence is part-of-speech tagged (using the Brill tagging convention) and then chunk parsed.

FIG. 4 shows a simple Korean example of text processing step where a sentence is part-of-speech tagged and then chunk parsed.

FIG. 5 illustrates possible English chunk rules which use regular expressions of part-of-speech tags and lexical items. Following the conventions of regular expression syntax, ‘jj*nn+’ means a pattern consists of 0 or more adjectives and 1 or more noun sequences.

FIG. 6 illustrates an overview of the realign module where an improved word alignment and one or more lexicon model are derived from the two directions of trainings of an existing statistical machine translation system with additional components.

FIG. 7 illustrates an overview of a decoder (also illustrated in FIG. 1) of the preferred embodiment of the invention.

FIG. 8 shows an example of input data to the decoder.

### DETAILED DESCRIPTION OF THE PREFERRED EMBODIMENTS

### System Overview

In the preferred embodiment of this present invention, a chunk-based statistical machine translation system offers many advantages over other known statistical machine translation systems. A presently preferred embodiment of the present invention can be constructed in a two step process. The first step is the training step where models are created for translation purposes. The second step is the translation step where the models are utilized to translate input sentences.

In the preferred embodiments of the present invention, two separate levels of training are performed to learn lexical and syntactic properties, respectively. To achieve this new model of translation, chunk alignment is provided in a statistical machine translation system.

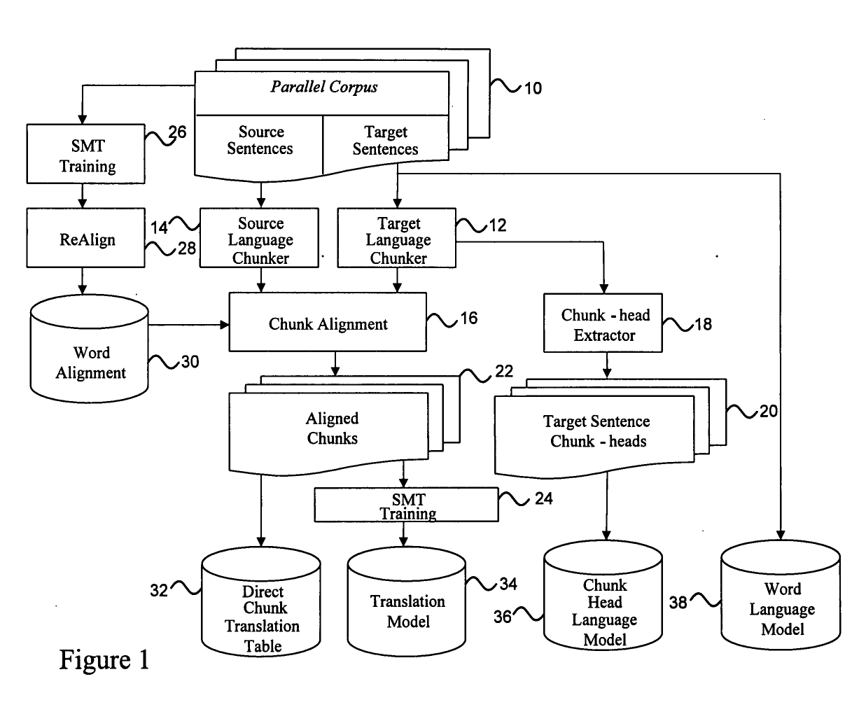

FIG. 1 illustrates the overview of the first step, the training step, in creating the chunk-based models and one or more tables. Referring to FIG. 1, from the parallel corpus (or sentence-aligned corpus) 10, the first statistical machine translation (SMT) training 26 is performed and a word alignment algorithm (realign) 28 is applied to generate word alignment information 30, which is provided to a chunk alignment module 16. Both the source language sentences and target language sentences are independently chunked (12 & 14) by given rules and then the chunks in the source languages are aligned to the chunks in the target language by the chunk alignment module 16 to generate aligned chunks 22. The derived chunk-aligned corpus 22 is used to perform another SMT training 24 to provide translation models 34 for statistical chunk translations. The aligned chunks also form a direct chuck translation table 32, which provides syntactic chunks and their associated target language translation candidates and their respective translation model probabilities. In this invention, the source and target languages denote the language translated from, and translated to, respectively. For example, in Korean-to-English translation, the source and target languages are Korean and English, respectively.

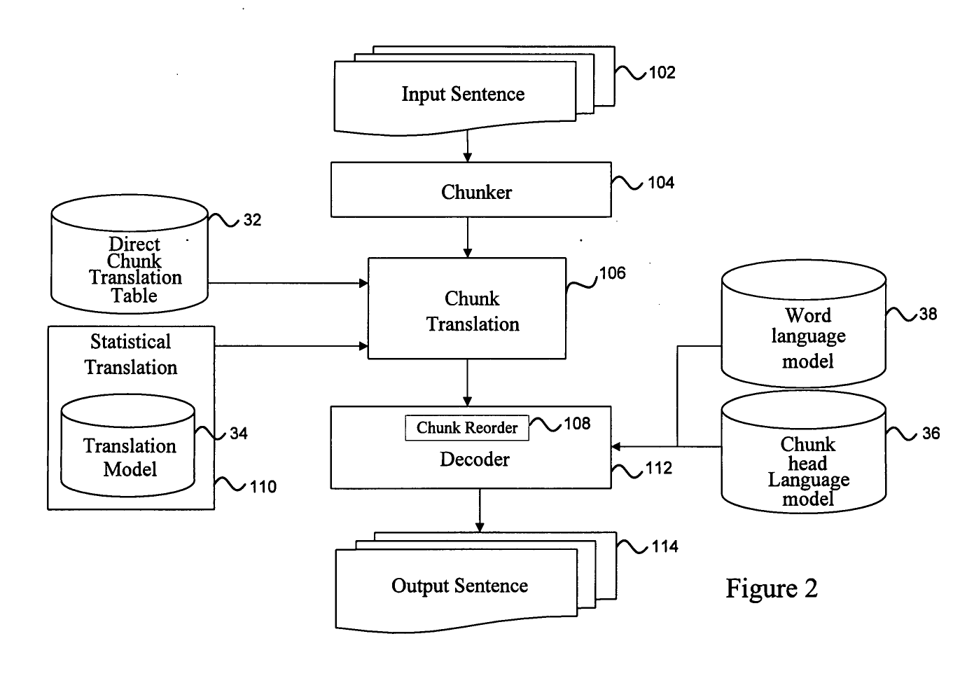

In the second step, the translation step, referring to FIG. 2, a sentence can be translated using the results (the direct chunk translation table, the translation models, a chunk head language model, and a word language model) obtained from the training step illustrated by FIG. 1. Input sentences 102 are chunked first by chunker 104 and each chunk can be translated using both a statistical method 110 and a look-up method 32. Reordering is performed at the chunk level rather than at word level 108. Among many translation candidates for each chunk, the decoder 112 selects optimal translation paths within context using the word language models 38 and the chunk head language models 36, and output sentences are generated 114.

Referring to FIG. 1, while purely statistical MT systems use word alignment from a parallel corpus (or sentence aligned corpus) to derive translation models, the present invention uses word alignment at 30 between sentences only to align chunks in the chunk alignment module 16. In addition, the chunks are found independently in both source and target language sentences via source language chunker 14 and target language chunker 12, regardless of the word alignment, which is contrasted to other phrase-based SMT systems (Och et al. 2000).

The aligned chunks 22 produced by chunk alignment 16 serve not only as the source for direct chunk translation table 32 but also as the training material of statistical chunk translation to produce translation models 34. The translation models such as lexical model, fertility model and distortion model within chunks are learned from the aligned chunks in the chunk-level training 24. This second level of SMT training is one of the important novel features of the invention. The learned models in this way tend to be more accurate than those learned from aligned sentences.

Initial target side corpus is used to build a word language model 38. The word language model is a statistical n-gram language model trained on target language corpus.

The chunked target sentences go through a chunk-head extractor 18 to generate target sentence of chunk-head which is used to build a chunk-head language model 36. The definition of chunk-head language model is a statistical n-gram language model trained on the chunk head sequences of the target language. The head word of a chunk is determined by the linguistic rules. For instance, the noun is the head of a noun phrase, and the verb is the head of a verb phrase. The chunk head language model can capture long distance relationship between words by omitting structurally unimportant modifiers. Chunk head language model is possible due to syntactic chunking, and it is another advantage of the invention.

Referring to FIG. 2, the translation component of the system consists of chunk translation 106, (optionally reordering 108), and decoding 112. The chunker 104 chunk parses the sentence into syntactic chunks and each chunk is translated by looking up candidate translations from the direct chunk translation table 32 and with a statistical translation decoding 110 method using the translation models 34 obtained during the chunk-level training.

Reordering 108 is performed using blocks of chunk translations instead of words, and multiple candidate translation of chunks are decoded using a word language model 38 and chunk head language model 36. Reordering can be performed before the decoder or integrated with the decoder.

### Linguistic Processing of the Training Corpus

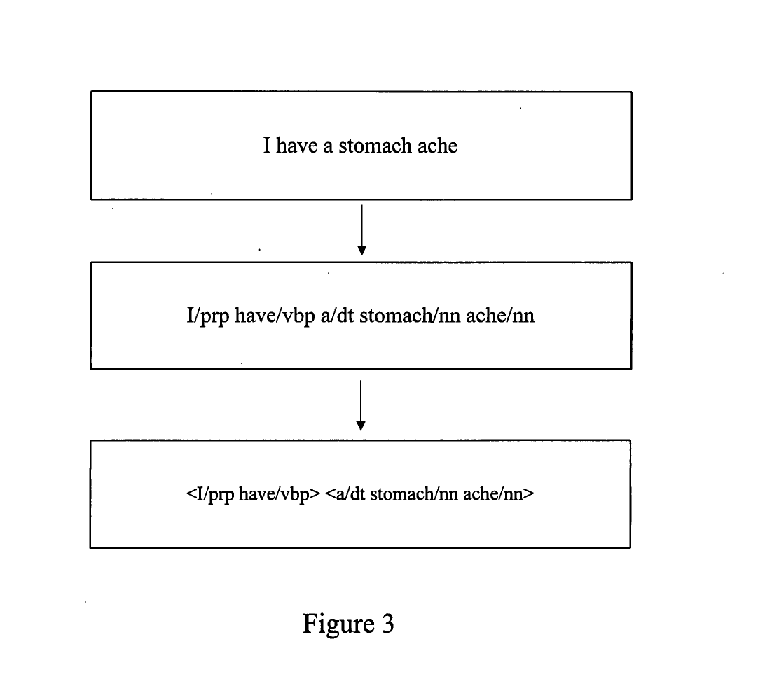

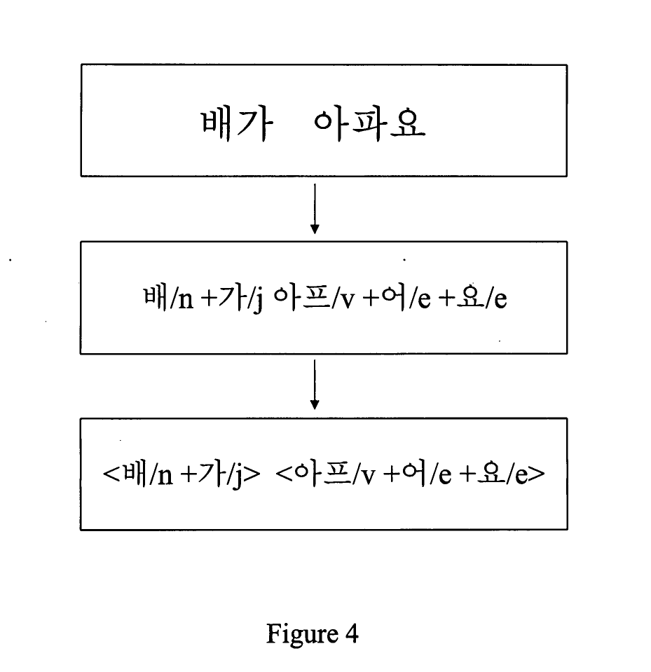

Depending on the language, linguistic processing such as morphological analysis and stemming is performed to reduce vocabulary size and to balance the source and target languages. When a language is inflectionally rich language, like Korean, many suffixes are attached to the stem to form one word. This leads one stem to have many different forms, all of which are translated into one word in another language. Since a statistical system cannot tell that all these various forms are related and therefore treats them as different words, a potentially severe data sparseness problem may result. By decomposing a complex word into prefixes, stem, and suffixes, and optionally removing meaningfully unimportant parts, we can reduce vocabulary size and mitigate the data sparseness problem. FIG. 3 shows a simple English example of text processing step: a sentence is part-of-speech tagged and then chunk parsed. FIG. 4 shows a simple Korean example of text processing step: a sentence is part-of-speech tagged and then chunk parsed. Not only part-of-speech tagging but also a morphological analysis is performed in the second box in the figure, which segments out suffixes (subject/object markers, verbal endings etc.). FIG. 4 illustrates the result of a morphological analysis of a Korean sentence, which is a translation of the English sentence in FIG. 3.

Part-of-speech tagging is performed on the source and target languages before chunking. Part-of-speech tagging provides syntactic properties especially necessary for chunk parsing. One can use any available part-of-speech tagger such as Brill's tagger (Brill 1995) for the languages in question.

### Chunk Parsing

With respect to chunker as illustrated by FIG. 2 at 104, syntactic chunking is not a full parsing but a simple segmentation of a sentence into chunks such as noun phrases, verb clusters, prepositional phrases (Abney et al. 1991). Syntactic chunking is a relatively simple process as compared to deep parsing. It only segments a sentence into syntactic phrases such as noun phrases, prepositional phrases, and verbal clusters without hierarchical relationships between phrases.

The most common way of chunking (Tjong 2000) in the natural language processing field is to learn chunk boundaries from manually parsed training data. The acquisition of such, however, is time consuming.

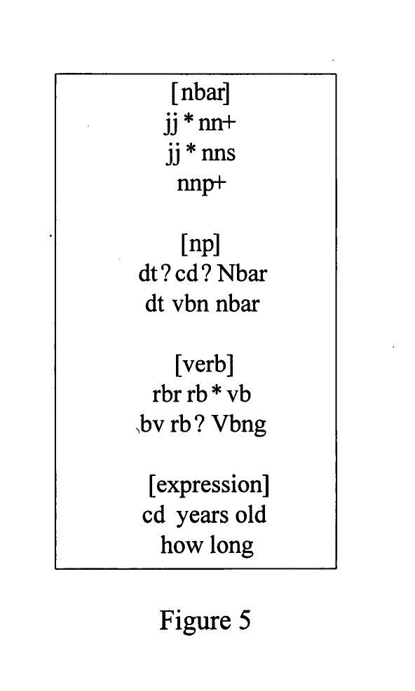

In this invention, part-of-speech information and a handful set of manually built chunking rules suffice to perform accurate chunking. For better performance, idioms can be used, which can be found with the aid of dictionaries or statistical methods. Syntactic chunking is performed on both source and target languages independently. Since the chunking is rule-based and the rules are written in a very simple form of regular expressions comprising of part-of-speech tags and lexical items, it is easy to modify the rules depending on the language pair. Syntactic chunks are easily definable, as shown in FIG. 5. FIG. 5 illustrates possible English chunk rules which use regular expressions of part-of-speech tags and lexical items. Following the conventions of regular expression syntax, ‘jj*nn+’ means a pattern consists of 0 or more adjectives and 1 or more noun sequences.

This method requires fewer resources and is easy to adapt to new language pairs. Chunk rules for each language may be developed independently. However, ideally, they should take into consideration the target language in order to achieve superior chunk alignment. For instance, when one deals with English and Korean in which pronouns are freely dropped, one can add a chunk rule which combines pronouns and verbs in English so that a Korean verb without a pronoun can have a better chance to align to an English chunk consisting of a verb and a pronoun. Multiple ways of chunking rules may be used to accommodate better chunk alignment.

Generally chunk rules are part-of-speech tag sequences but they may also be mixed, comprise of both part-of-speech tags and lexical items, or even comprise of lexical items only, to accommodate idioms as illustrated in FIG. 5. The priority is given in the following order: idioms, mixed rules, and syntactic rules. Idioms can be found from dictionaries or via statistical methods. Since idioms are not decomposable unit, it is better for them to be translated as a unit, hence it is useful to define idioms as a chunk. For instance “kick the bucket” should be translated as a whole instead of being translated as two chunks ‘kick’ and ‘the bucket’, which might be the result of chunk parsing with only syntactic chunk rules.

When there is no existing parallel corpus, and one has to build one from scratch, one can even build a parallel chunk corpus. As syntactic chunks are usually psychologically independent units of expression, one can generally translate them without context.

### Word Alignment (ReAlign)

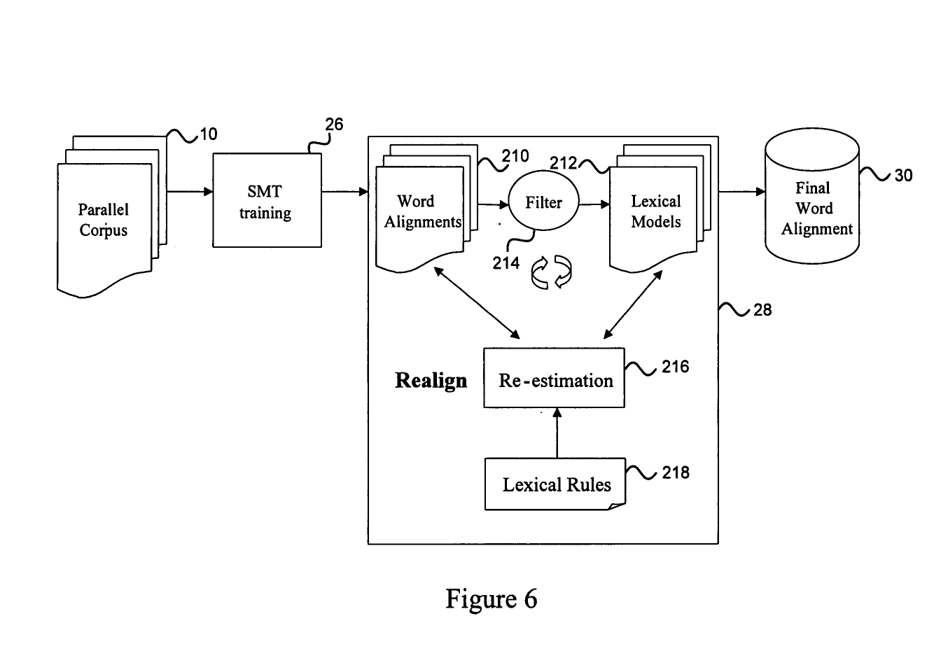

Referring to FIGS. 1 and 6 at 28, Realign takes different alignments from SMT Training 26 as inputs, and uses lexical rules 212 and constrained machine learning algorithms to re-estimate word alignments in a recursive way. FIG. 6 illustrates an overview of the Realign process where the parallel corpus 10 is SMT trained 26 and realigned 28 to produce the final word alignment 30. This process is also described in FIG. 1. The preferred embodiment improved word alignment 210 and lexicon model 212 from the two directions of trainings of an existing statistical MT system with additional components.

Referring to FIG. 6 at 216, a machine learning algorithm is proposed to perform word alignment re-estimation. First, an existing SMT training system such as GIZA++ can be used to generate word alignments in both forward and backward directions. An initial estimation of the probabilistic bi-lingual lexicon model is constructed based on the intersection and/or union of the two word alignment results. The resulting lexicon model acts as the initial parameter set for the word re-alignment task. A machine learning algorithm, such as maximum likelihood (ML) algorithm generates a new word alignment using several different statistical source-target word translation models. The new word alignment is used as the source for the re-estimation of the new lexicon model in next iteration. The joint estimation of the lexicon model and word alignment is performed in an iterative fashion until a certain threshold criterion such as alignment coverage is reached.

In IBM models 1-5 (Brown et al, 1993), the relationship between word alignment and lexical model is restricted to one-to-one mapping, and only one specific model is utilized to estimate parameters of statistical translation model. In contrast to IBM models, the approach of the present invention combines different lexicon model estimation approaches with different ML word alignments in each iteration of the model training. As a result, the system is more flexible in terms of the integration of the lexicon model and the word alignment during the recursive estimation, and thus can improve both predictability and precision of the estimated lexicon model and word alignment. Different probabilistic models are introduced in order to estimate the associativity between the source and target words. First, a maximum a posteri (MAP) algorithm is introduced to estimate the word translation model, whereas the word occurrence in the parallel sentences is used as a posteri information. Furthermore, we estimate the lexicon model parameters from the marginal probabilities in the parallel sentence, besides the global information in the entire training corpus. This approach will increase the discriminativity of learned lexical model and word alignment, by considering the local context information embedded in the parallel sentence. As a result, this approach is capable of increasing the recall ratio of word alignment and the lexicon size without decreasing the alignment precision, which is especially important for applications with limited training parallel corpus.

Referring to FIG. 6 at 218, this invention also introduces lexical rules to constrain the optimal estimation of word alignment parameters. Given a source sentence \vec{s}=s₁, s₂, . . . , s_{I} and a target sentence \vec{t}=t₁, t₂, . . . , tⱼ, we want to find the target word tⱼ which can be generated by source word sᵢ according to certain optimal criterion. Alignment between source and target words may be represented by an I×J alignment matrix A=[aᵢⱼ], such that aᵢⱼ=1 if sᵢ is aligned to tⱼ, and aᵢⱼ=0 otherwise. The constrained ML based word alignment can be formulated as follows:

$${A}^{*} = {arg max}_{A ∈ {Φ}_{L}} p ( \vec{t} , A \vert \vec{s} ) \qquad ( 1 )$$

where Φ_{L} denotes the set of all possible alignment matrices subject to the lexical constraints. The conditional probability of a target sentence generated by a source sentence depends on the lexicon translation model. Lexicon translation probability can be modeled in numerous ways, i.e. using the source-target word co-occurrence frequency, context information from the parallel sentence, and the alignment constraints. During each iterations of the word alignment, the lexical translation probabilities for each sentence pair are re-estimated using the lexical model learned from previous iterations, and the specific source-target word pairs occurring in the sentence.

Referring to FIG. 6 at 214, the invention also uses lexical rules to filter out unreliable estimations of word alignments. The preferred embodiment of the invention utilizes several kinds of lexical constraints for word alignments filter. One constraint set comprises of functional morphemes such as case marking morphemes in one language, which should be aligned to the NULL word in the target language. Another constraint set contains frequent bi-lingual word pairs which are incorrectly aligned from the initial word alignment. One may use frequent source target word translation pairs which are manually corrected or selected from the initial word alignment results of SMT training. Realignment improves both precision and recall of word alignment when these lexical rules are used.

### Chunk Alignment

Referring to FIG. 1 at 16, to allow the two-level training, both the source and target sentences are independently segmented into syntactically meaningful chunks and then the chunks are aligned. The resulting aligned chunks 22 serves as the training data for the second SMT 24 for chunk translation as well as the direct chunk translation table 32. There are many ways of chunk alignment, but one possible embodiment is to use word alignment information with part-of-speech constraints.

One of main problems of the word alignment in other SMT systems is that many words are incorrectly unaligned. In other words, the recall ratio of word alignment tends to be low. Chunk alignment, however, is able to mitigate this problem. Chunks are aligned if at least one word of a chunk in the source language is aligned to a word of a chunk in the target language. The underlying assumption is that chunk alignments are more one-to-one than word alignment. In this way, many words that would not be aligned by the word alignment are included in chunk alignment, which in turn improves training for chunk translation. This improvement is possible because both target language sentences and source language sentences are independently pre-segmented in this invention. For a phrase-based SMT such as Alignment Template Model (Och et al. 2000), this kind of improvement is less feasible. The “phrases” of Alignment Temple Model are solely determined by the word alignment information and the quality of word alignment is more or less the only thing to determine the quality of phrases found in their model.

Another major problem of the word alignment is that a word is incorrectly aligned to another word. This low precision problem is a much harder problem to solve and potentially leads to greater translation quality degradation. This invention overcomes this problem in part by adding a constraint using part-of-speech information to selectively use more confident alignment information. For instance, we can filter out certain word alignments if the part-of-speech of the aligned words are incompatible. In this way, possible errors in word alignment are filtered out in chunk alignment.

Compared to word alignment, the one-to-one alignment ratio is high in chunk alignment (i.e. the fertility is lower), but there are some cases that one chunk is aligned to more than one chunk in the other language. To achieve a one-to-one chunk alignment, the preferred embodiment of the present invention allows chunks to be merged or split.

### Chunk Translation

Referring to FIG. 2 at 106, the chunk-based approach has two independent methods of chunk translation:
(1) direct chunk translation
(2) statistical decoding translation using SMT training on aligned chunks.

The direct chunk translation uses the direct chunk translation table 32 with probability constructed from the chunk alignment. The chunk translation probability is estimated from the co-occurrence frequency of the aligned source-target chunk pair and the frequency of the source chunk from chunk alignment table. Direct chunk translation has the advantage of handling both word order problems within chunks as well as translation problems of non-compositional expressions, which covers many translation divergences (Dorr 2002). While the quality of direct chunk translation is very high, the coverage may be low. Several ways of chunking with different rules may be tested to construct a better direct chunk translation table to balance quality and coverage.

The second method is a statistical method 110, which is basically the same as other statistical methods except that the training is performed on the aligned chunks rather than the aligned sentences. As a result training time is significantly reduced and more accurate parameters can be learned to produce better translation models 34. To make a more complete training corpus for chunk translation, we can use not only the aligned chunks but also statistical phrases generated from another phrase-based SMT system. One can also add the lexicon table from the first SMT training. The addition of the lexicon table significantly reduces oov's (out of vocabulary items).

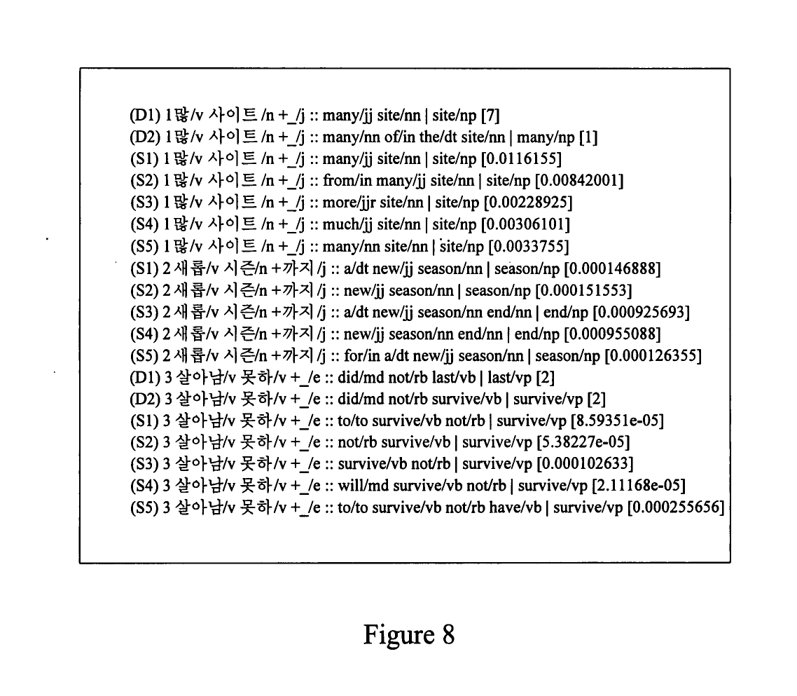

As shown in FIG. 8, the preferred embodiment of the invention obtains multiple candidate translations from both direct translation and the statistical translation for each chunk. From a direct method, the top n-best chunk translations are found from the direct chunk table, if the source chunk exists. From the statistical method, top n-best translations are generated for the source chunk. These chunk translation candidates with their associated probabilities are used as input to the decoder to generate a sentence translation.

### Reordering of Chunks

Referring to FIG. 2 at 108, a chunk-based reordering algorithm is proposed to solve the long-distance movement problem in machine translation. Word-based SMT is inadequate for language pairs that are structurally very different, such as Korean and English, as distortion models are capable of handling only local movement of words. The unit of reordering in this invention is the syntactic chunk. Note that reordering can be performed before the decoder or integrated with the decoder.

In contrast, syntactic chunks are syntactically meaningful units and they are useful to handle word order problems. Word order problems can be local, such as the relation between the head noun and its modifiers within a noun phrase, but more serious word order problems deal with long distance relationships, such as the order of subject, object and the verb in a sentence. These long distance word order problems become tractable when we shift the unit of reordering from words to syntactic chunks.

The “phrases” found by a phrase-based statistical machine translation model (Och et al. 2000) are bilingual word sequence pairs in which words are aligned with other. As they are derived from word alignment, the phrase pairs are good translations from each other, but they are not good syntactic units. Hence, reordering using such phrases may not be as advantageous as reordering based on syntactic chunks.

For language pairs with very different word order, one can perform heuristic transformations to move around chunks into another position to make one language word order more similar to the other language to improve translation quality. For instance, English is a SVO (subject-verb-object) language, while Korean is a SOV (subject-object-verb). If the Korean noun phrases marked by the object marker are moved before the main verb, the transformed Korean sentences will be more similar to English in terms of word order.

In terms of reordering, the decoder need only consider permutations of chunks and not words, which is a more tractable problem.

In the preferred embodiment of the invention, chunk reordering is modeled as the combination of traveling salesman problem (TSP) and global search of the ordering of the target language chunks. The TSP problem is an optimization problem that tries to find the path to cover all the nodes in a direct graph with certain defined cost function. For short chunks, we perform global search of optimally reordered chunks using target language model (LM) scores as cost function. For long chunks, we use TSP algorithm to search for sub-optimal solution using LM scores as cost function.

For chunk reordering the LM score between contiguous chunks acts as the transitional cost between two chunks. The LM score is obtained through the log-linear interpolation of an n-gram based lexicon LM and an n-gram based chunk head LM. A 3-gram LM with Good-Turing discounting, for example, is used to train the target language LM. Due to the efficiency of the combined global search and TSP algorithm, a distortion model is not necessary to guide the search for optimal chunk reordering paths. The performance of reordering in this model is superior to word-based SMT not only in quality but also in speed due to the reduction in search space.

### Decoding

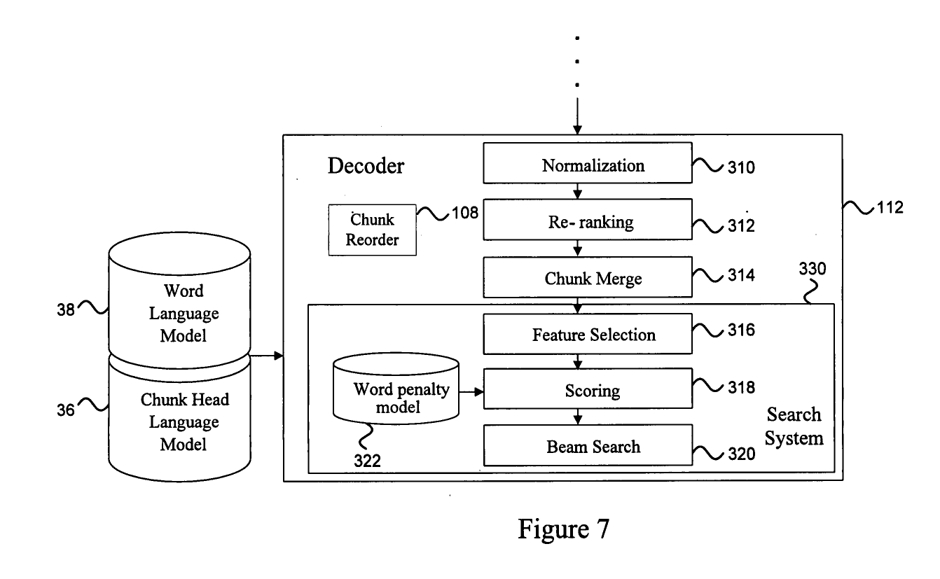

An embodiment of a decoder of this invention, as depicted in FIG. 7, is a chunk-based hybrid decoder. The hybrid decoder is also illustrated at 112 in FIG. 2. During the decoding stage, N-best chunk translation candidates, as illustrated in FIG. 8, from both direct table and statistical translation model are produced from the chunk translation module. The associated probabilities of these translated chunks are first normalized based on the global distributions of direct chunk translation and statistical translation chunks separately and subsequently merged using optimized contribution weights. FIG. 7 provides an overview of an embodiment of a decoder of the present invention. Unlike other statistical machine translation decoding systems, the hybrid decoder in this invention handles multiple sources of chunk translations with multiple language models. Hence, it has a component to normalize probabilities of the two sources of translations 310, re-ranking 312, and merging chunk translations 314. The decoder also contains a search system 330, which has a component to select decoding features 316; a component for hypothesis scoring; a beam search module 320; and a word penalty model 322.

FIG. 8 shows the processing of an input to the decoder. A sentence is chunk parsed and each chunk has multiple translation candidates from both the direct table (D) and statistical translation (R) with frequency or probabilities. Each chunk translation has the chunk head as well, so that the chunk head language model can be used to select the best chunk in the context.

Referring to FIG. 7 at 36 and 38, a word LM 38 and chunk head LM 36 are used to predict the probability of any sequence chunk translations. The chunk-head LM is trained from the chunk parsed target language, and a chunk head is represented as the combination of chunk head-word and the chunk's syntactic type. The chunk-head LM captures the long distance relation which is hard to deal with by a traditional trigram word language model. Fine-grained fluency between words is achieved by the word LM.

Referring to FIG. 7 at 310, a normalization algorithm is introduced to combine chunk translation models trained from different SMT training methods. The algorithm employs first and second order statistics in order to merge multiple distributions.

Referring to FIG. 7 at 312, chunk translation candidates are reranked using multiple sources of information, such as, normalized translation probability, source and target chunk lengths, and chunk head information.

Referring to FIG. 7 at 314, the normalized and re-ranked source-target chunk pairs are merged into final chunk translation model, which is used as one scoring function for the hybrid SMT decoder. If a source-target chunk appears in multiple translation models, we use information such as normalized translation probability and chunk rank to merge them into a unified translation model. Thereby the decoder in this invention provides a framework for integrating information from multiple sources for hybrid machine translation.

The merged and normalized chunk segments are organized into a two-level chunk lattice in order to facilitate the re-ranking of source-target chunk pairs with multi-segmentation schemes, and the search algorithm. The first level of chunk lattice consists of source chunks starting at different positions in the source sentence. The second level of the lattice contains source chunks with the same starting position, and different ending positions in the source sentence, and their corresponding target chunks merged from different translation models.

Referring to FIG. 7 at 330, a search algorithm is proposed to generate sentence-level translation based on merged translation model and other statistical models such as LM. The search system consists of a feature selection module 316, a scoring component 318, and an efficient beam search algorithm 320.

Referring to FIG. 7 at 316, a feature selection module is used to select discriminative features for SMT decoding. Unlike the traditional approach which combines different sources of information under a log-linear model (Och et al., 2002), this invention represents and encodes different linguistic and statistical features under a multi-layer hierarchy. The first level of information fusion uses statistical models to combine structural transformations between source and target languages, such as semantic coherence, syntactic boundaries, and statistical language models for MT decoding. The contributions from different models can be automatically trained from supervised or semi-supervised learning algorithms. A possible embodiment is a method using Maximum Entropy (MaxEnt) modeling with either automatically or semi-automatically extracted features. The second level of the decoder captures the dynamic and local information embedded in source and target sentences, or segments of the parallel sentences. A unified probabilistic model is introduced to re-rank and merge segmental features from different sources for hybrid machine translation. Under such framework, one can seamlessly combine different translation models, such as linguistic-driven chunk-based approach, and statistical-based Alignment Template Model, and both global and local linguistic information to better handle the translation divergences with limited training parallel corpus.

Referring to FIG. 7 at 322, a word penalty model is necessary to compensate for the fact that the LM systematically penalizes longer target chunks in the search space. We introduce a novel word penalty model, which gives us estimation of the decoding length penalty/reward with respect to the chunk length, and a dynamically determined model parameter.

Referring to FIG. 7 at 318, a scoring module is used to compute the cost of translation hypotheses. Our scoring function is a log-linear model which combines the costs from statistical models such as LM and merged translation models, and other models such as word penalty model, chunk-based reordering model, and covered source words.

Referring to FIG. 7 at 320, a novel beam search algorithm is introduced to perform ordered search of translation hypotheses. Unlike other SMT decoders, which only consider sub-optimal solution inside the entire search space, our search algorithm is a combination of an optimal search and a multi-stack best-first sub-optimal search, which finds the best sentence translation while keeping the efficiency and memory requirements for SMT decoding. The decoder conducts an ordered search of the hypotheses space, and builds solutions incrementally and stores partial hypotheses in stacks. At the same search depth, we also deploy multiple stacks to solve the problem of shorter hypotheses overtaking longer hypotheses although the longer one is a better translation. We also address the issue of extending multiple stacks by taking one optimal hypothesis from each stack, and only extending the one with lowest cumulative cost. As a result, our real-time decoder is capable of processing more than ten sentences per second, with translation quality comparable to or higher than other SMT decoders.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A translation method, comprising the steps of:
receiving an input sentence;
chunking the input sentence into one or more chunks;
translating the chunks; and
decoding the translated chunks to generate an output sentence.

2. The translation method of claim 1 wherein in the translating step, a direct chunk translation table is used for translating the chunks.

3. The translation method of claim 1 wherein in the translating step, a statistical translation model is used for translating the chunks.

4. The translation method of claim 2 wherein in the translating step, a statistical translation model is used for translating the chunks.

5. The translation method of claim 1 wherein in the decoding step, the translated chunks are reordered.

6. The translation method Qf claim 5 wherein in the reordering step, multiple language models are used for reordering the chunks.

7. The translation method of claim 5 wherein in the reordering step, one or more search methods can be used for reordering the chunks.

8. The translation method of claim 5 wherein in the reordering step, a chunk head language model is used for reordering the chunks.

9. The translation method of claim 6 wherein in the reordering step, a chunk head language model is used for reordering the chunks.

10. The translation method of claim 1 wherein in the decoding step, multiple language models are used for decoding the chunks.

11. The translation method of claim 1 wherein in the decoding step, a chunk head language model is used for decoding the chunks.

12. The translation method of claim 10 wherein in the decoding step, a chunk head language model is used for decoding the chunks.

13. The translation method of claim 1 wherein in the decoding step, translated chunks generated from two or more independent methods are normalized and merged.

14. The translation method of claim 1 wherein in the chunking step, input sentences are chunked by chunk rules.

15. The translation method of claim 1, wherein training models are generated for use in this translation method, comprising the steps of:
chunking a source language sentence from a corpus to generate source language chunks;
chunking a corresponding target language sentence from a corpus to generate target language chunks; and
aligning the source language chunks with the target language chunks.

16. The translation method of claim 15, further comprising the step of generating a direct chunk translation table using aligned chunks.

17. The translation method of claim 15, further comprising the step of generating one or more translation models using aligned chunks.

18. The translation method of claim 15, further comprising the step of extracting chunk heads.

19. The translation method of claim 18, further comprising the step of generating one or more chunk head language models using extracted chunk heads.

20. The translation method of claim 15, further comprising the step of generating word alignment information using lexical constraints from source and target sentences.

21. The translation method of claim 15, wherein in the aligning step, chunks are aligned with word alignment and part-of-speech constraints.

22. A translation method, comprising the steps of:
receiving an input sentence;
chunking the input sentence into one or more chunks using chunk rules;
translating the chunks using a direct chunk translation table and statistical translation model;
reordering the chunks using multiple language models, one or more search methods, and a chunk head language model; and
decoding the reordered chunks to generate an output sentence, using multiple language models and a chunk head language model.
